(19) United States
(12) Patent Application Publication
(10) Pub. No.: US 2003/0193526 A1
(43) Pub. Date: Oct. 16, 2003

(54) Hierarchical data structure which enables interactive visualization of a geographical space

(76) Inventors: Mark E. Stegbauer, Southgate, MI (US); Jeffrey M. Roberts, Commerce, MI (US); Michael C. French, Sterling Heights, MI (US)

Correspondence Address: HARNESS, DICKEY & PIERCE, P.L.C., P.O. BOX 828, BLOOMFIELD HILLS, MI, 48303, US

(21) Appl. No.: 10/122,443

(22) Filed: Apr. 12, 2002

(51) Int. Cl. G09G 5/00

(52) U.S. Cl. 345/848; 345/853

(57) ABSTRACT

An interactive visualization tool is provided that enables its users to build, modify and interactively view three-dimensional simulation models of a particular geographical space over time. The interactive visualization tool is adapted to receive a user specified time and subsequently render the geographical space in accordance with the specified time. To represent a geographical space over time, the interactive tool employs a scene definition data structure. The scene definition data structure is comprised of a hierarchical tree structure having a plurality of nodes, such that each node represents a physical structure in the geographical space. Each node is further defined to include a time period during which the physical structure exists in the geographical space and link data to the corresponding three-dimensional model data for the physical structure.

### FIELD OF THE INVENTION

The present invention relates generally to an interactive visualization tool and, more particularly, to a hierarchical data structure which enables interactive visualization of a geographical space over time.

### BACKGROUND OF THE INVENTION

Interactive visualization tools are commonly employed in the computer gaming industry. In this application, three-dimensional simulation models rendered by the visualization tool represent a fictitious location. In contrast, constructing three-dimensional simulation models to represent actual geographical locations is an emerging application for interactive visualization tools. In the known applications, interactive visualization tools allow a user to view a particular geographical location as it has been modeled at a given point in time. Although interactively viewing a geographical location has proven to be beneficial to architects, interior designers, city planners and others, known visualization tools provide limited (if any) capability to model the geographical location over time.

Therefore, it is desirable to provide an interactive visualization tool which allows architects, interior designers, city planners and others to build, modify and interactively view three-dimensional simulation models for a given geographical location over time.

### SUMMARY OF THE INVENTION

In accordance with the present invention, an interactive visualization tool is provided that enables its users to build, modify and interactively view three-dimensional simulation models of a particular geographical space over time. The interactive visualization tool is adapted to receive a user specified time and subsequently render the geographical space in accordance with the specified time. To represent a geographical space over time, the interactive tool employs a scene definition data structure. The scene definition data structure is comprised of a hierarchical tree structure having a plurality of nodes, such that each node represents a physical structure in the geographical space. Each node is further defined to include a time period during which the physical structure exists in the geographical space and link data to the corresponding three-dimensional model data for the physical structure.

For a more complete understanding of the invention, its objects and advantages, reference may be had to the following specification and to the accompanying drawings.

### BRIEF DESCRIPTION OF THE DRAWINGS

FIG. 1 is a block diagram of an exemplary interactive visualization tool in accordance with the present invention;

FIG. 2 is a diagram of a hierarchical tree structure that may be used to represent a geographical space in accordance with the present invention;

FIG. 3 is a flowchart illustrating processing steps for viewing a requested scene in accordance with the present invention;

FIG. 4 is a diagram depicting three hierarchical data structures used to represent a geographical space in accordance with the present invention;

FIG. 5 illustrates an exemplary graphical user interface for the interactive visualization tool of the present invention; and

FIGS. 6A and 6B illustrates exemplary pop-up windows which allows a user to modify a visual simulation attribute associated with a physical structure in the requested scene in accordance with the present invention.

### DETAILED DESCRIPTION OF THE PREFERRED EMBODIMENTS

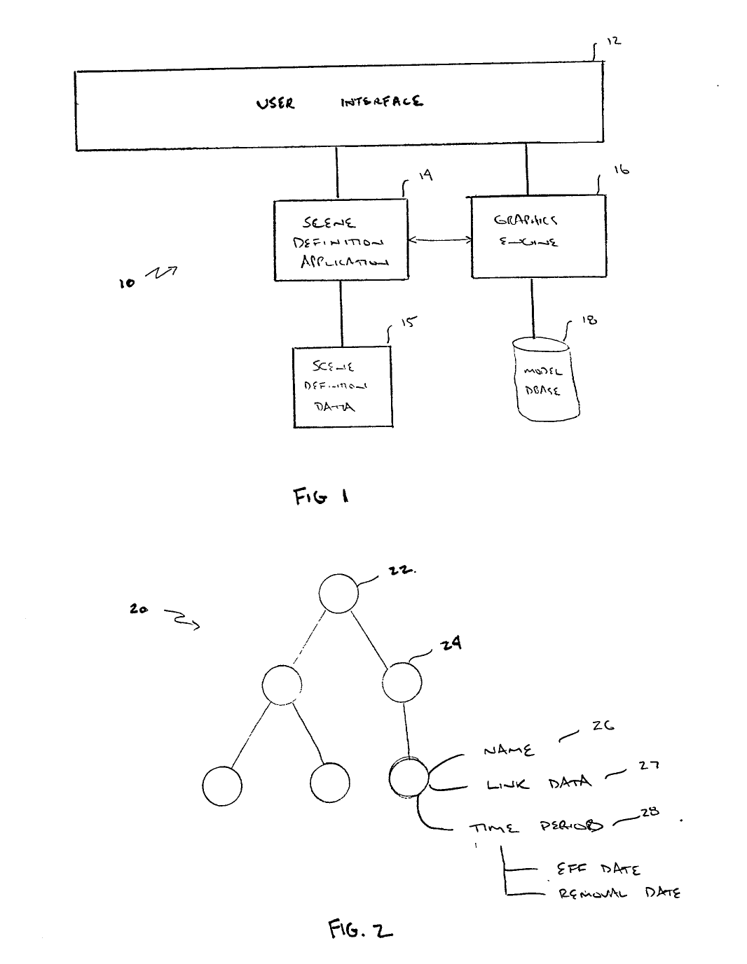

An exemplary interactive visualization tool 10 is depicted in FIG. 1. The interactive visualization tool 10 is a software-implemented application that allows it users to build, modify and interactively view three-dimensional simulation models of a particular geographical space. In accordance with the present invention, the interactive visualization tool 10 allows a user to set a desire point in time. The interactive visualization tool 10 is then operable to interactively display the geographical space in accordance with the specified time.

To represent a geographical space over time, the interactive tool 10 employs a scene definition data structure 15. The scene definition data structure 15 is preferably comprised of one or more hierarchical tree structures, such that each different tree structure represents a different geographical space. For instance, a tree structure may be used to represent the city of Birmingham; whereas another tree structure may be used to represent the city of Troy. Alternatively, one tree structure may be used to represent the greater Detroit metropolitan area, such that the city of Birmingham and the city of Troy are represented by a series of nodes within this one tree structure.

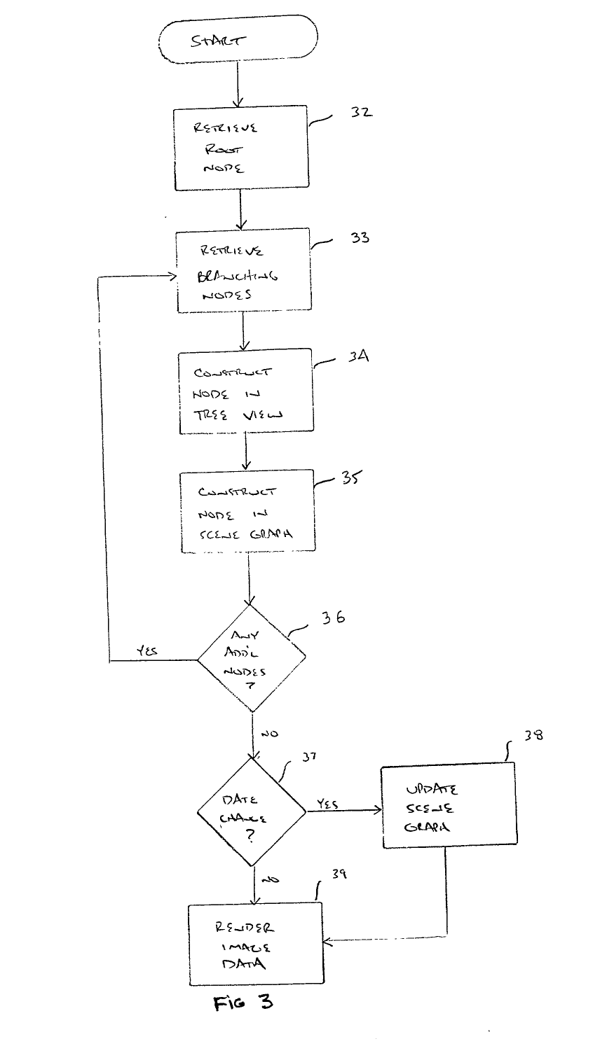

An exemplary hierarchical tree structure 20 is illustrated in FIG. 2. Each tree structure 20 includes a root node 22 and a plurality of branching nodes 24. The root node 22 signifies a particular geographical space; whereas each branching node 24 (either by itself or through its children) represents a physical structure residing in the geographical space. For instance, a branching node may represent a building on a street, a room residing in a building, or an object within the room.

Each branching node is further defined to include an identifiable name 26 for the physical structure, link data 27 to the corresponding three-dimensional model data for the physical structure, and a time period 28 during which the physical structure exists in the geographical space. In particular, the time period 28 may be specified by an effective date and a removal date. In one embodiment, the scene definition data structure may be implemented in an object oriented form, where the nodes are data objects instantiated from a common object class and assembled in a direct acyclic graph. Thus, the scene definition data structure 20 dictates the image data rendered by the interactive visualization tool 10 as further described below.

Returning to FIG. 1, the interactive visualization tool 10 is primarily comprised of a user interface component 12, a scene definition application 14, a graphics engine 16 and its associated model database 18, and the above described scene definition data structure 15. In one embodiment, the visualization tool may be implemented in a Microsoft Windows environment residing on a personal computer. In this embodiment, the user interface component 12 is implemented using standard Windows user interface controls as is known in the art. The scene definition application 14 is preferably a custom developed software application as further described below; whereas the graphics engine 16 and its associated model database 18 may be implemented though custom developed software and/or one of a variety of commercially available software products. An exemplary graphics engine software product is the NetImmerse 3D game engine available from Numerical Design Ltd. of Chapel Hill, N.C.

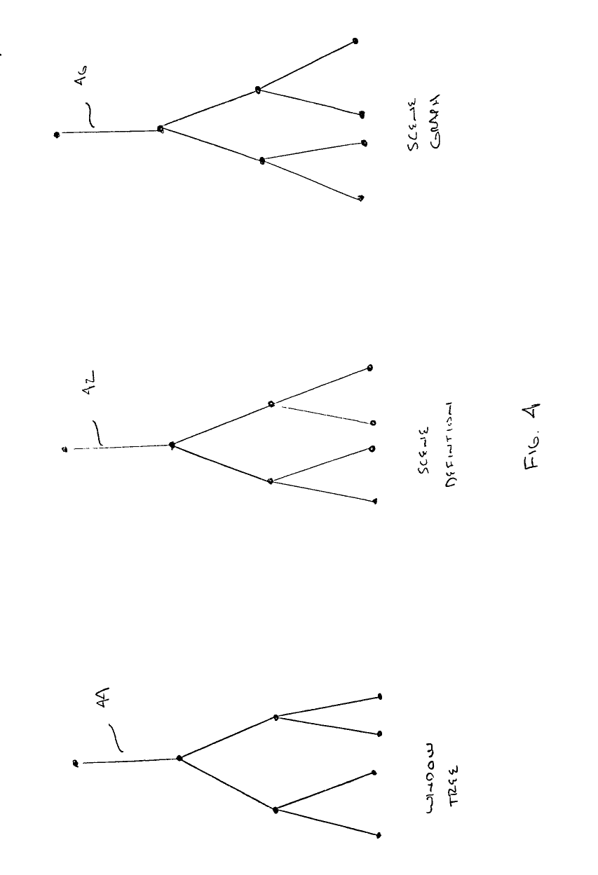

In general, the scene definition application 14 governs the overall operation of the interactive visualization tool 10. To view a scene, the scene definition application 14 performs the processing steps depicted in FIG. 3. It is to be understood that only the relevant steps of the scene definition application are discussed in relation to FIG. 3, but that other software-implemented instructions may be needed to control and manage the overall operation of the system.

Scene definition stems from a root node of a hierarchical tree structure as described above. The scene definition application 14 retrieves a root node for the requested scene from the scene definition data structure 15 as shown at step 32. The scene definition application 14 then retrieves the remainder of the corresponding hierarchical tree structure from the scene definition data structure 20. It is readily understood that the hierarchical tree structure is retrieved into a readily accessible memory space from a persistent data store associated with the computing device.

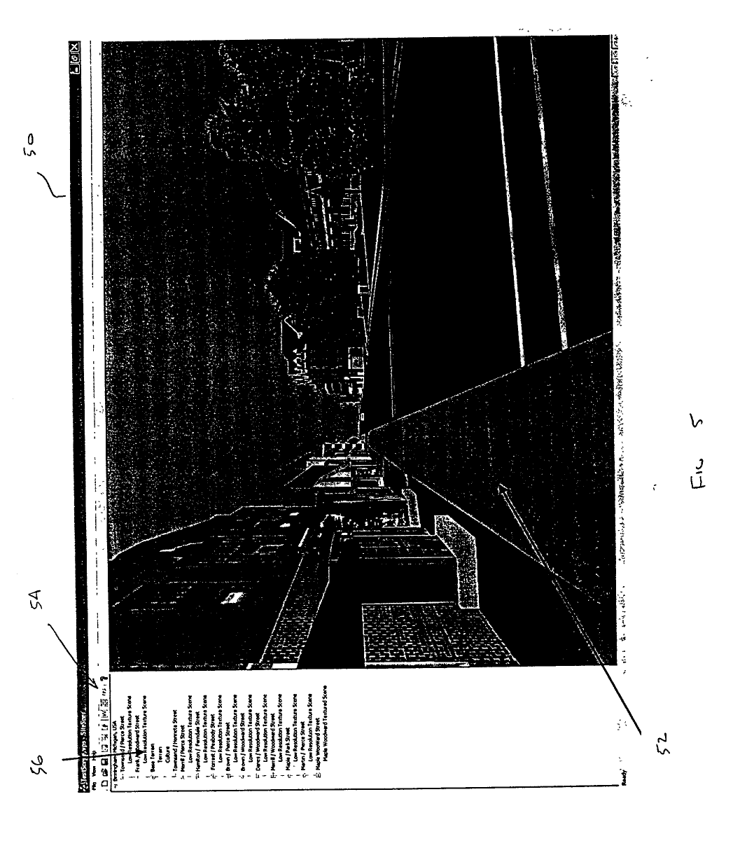

Next, the scene definition application 14 dynamically builds two data structures which parallel the hierarchical tree structure 42 retrieved from the scene definition data structure 15 as shown in FIG. 4. The first parallel data structure is a window tree 44 which is displayed on the graphical user interface of the tool. The window tree may be implemented using the well known tree view function as provided by the standard Windows programming environment. An exemplary window tree 56 is illustrated in FIG. 5. The second parallel data structure is a scene graph 46. The scene graph 46 is a well known hierarchical data structure built and used by the graphics engine 16 to render image data.

To dynamically build these two data structures, the scene definition application 14 traverses the hierarchical tree structure 42 retrieved from the scene definition data structure 15. For each node, the scene definition application 14 requests construction of a corresponding node in each of two parallel data structures.

First, the scene definition application 14 issues a command at step 34 to the Windows operating environment 12. The command (at a minimum) includes the name for the requested node. In response to the issued command, the operating environment instantiates a corresponding node in the window tree 44 and returns a pointer (i.e., memory address) for the node to the scene definition application 14. The pointer data is then stored by the requesting node in the hierarchical tree structure 42.

Second, the scene definition application 14 issues a command at step 35 to the graphics engine. In this case, the command includes link data (e.g., a file name or file address) for the corresponding model data residing in the model database 18 associated with the graphics engine 16. Similarly, the graphics engine 16 creates a corresponding node in the scene graph 46 and returns a pointer to the scene definition application 14. The pointer data is also stored by the requesting node in the hierarchical tree structure 42.

In this way, each node is each data structure represents the same physical structure in the geographical space. In other words, all three data structures represent the same hierarchy, and thus the same geographical space. Of particular importance, corresponding nodes in each data structure are linked together through the pointer data stored at each node in the hierarchical tree structure 42. Thus, the hierarchical tree structure 42 serves as the controlling data structure for the interactive visualization tool.

In accordance with the present invention, the scene definition application 14 renders the scene in accordance with a specified time input by the user. Although not limited thereto, the user specified time is preferably in date format. In one embodiment, the scene definition application 14 prompts the user for a specified view date each time a different scene is requested by the user. Alternatively, the scene definition application 14 may rely on a previously specified view date to render the scene. In this alternative embodiment, the scene definition application 14 allows the user to change the specified view date. In either case, the scene definition application 14 stores the most recently specified view date in a persistent data store.

Prior to rendering the scene, the scene definition application 14 determines whether the user specified view date has changed at step 37. When the specified view date changes, the scene definition application 14 must further update the scene graph 46 as shown at step 38. Each node in the scene graph has a corresponding switch node. Switch nodes are two-way switches that dictate whether three-dimensional model data is rendered by the graphics engine 16. When a switch node is set to a display mode, the model data associated with the node in rendered by the graphics engine 16. On the other hand, when a switch node is set to a non-display mode, the model data associated with the node is ignored by the graphics engine 16. In this way, switch nodes may be used to control the model data rendered in a given scene.

To update the scene graph, the scene definition application 14 recursively traverses each node in the hierarchical tree structure for the requested scene. At each node, the scene definition applications 14 checks the specified view date against the time period embodied in the given node. When the specified view date falls within the time period, the scene definition application 14 issues a request to set the corresponding switch to a display mode. When the specified view date falls outside the time period, the scene definition application 14 issues a request to set the corresponding switch node to a non-display mode. It is envisioned that the scene definition application 14 may be configured to update the switch node only if it needs to be changed. It is readily understood that this determination is easily made from the currently specified view date, the most recently specified view date, and the time period from a given node in the hierarchical tree structure.

Lastly, the image data is rendered in accordance with the specified view date by the interactive visualization tool as shown at step 39. Specifically, the graphics engine 16 retrieves and culls three-dimensional model data from the model database 18 and then translates it to two-dimensional data for display on the graphical user interface of the tool as is known in the art.

FIG. 5 illustrates an exemplary graphical user interface 50 for rendering the scene. The graphical user interface 50 is preferably divided into three components. A primary window 52 displays a three-dimensional representation of the requested scene. Various user commands may then be used to interactively view the scene. User commands, such as mouse position, mouse clicks and keyboard input, are captured by the Windows operating environment. User commands which are intended to manipulate the scene are directly passed to the graphics engine 16. The graphics engine 16 in turn responds to the commands by rendering the appropriate image data for the scene as is known in the art.

The interactive visualization tool 10 also allows a user to modify visual simulation attributes associated with the scene. To facilitate this user interaction, the graphical user interface 50 further includes a tool bar 54 disposed along the top of the display and a window tree 56 disposed along the left side of the display. As described above, the window tree 56 includes a branch for each physical structure residing in the geographical space. To change an attribute associated with a particular physical structure, the user selects the applicable branch from the window tree.

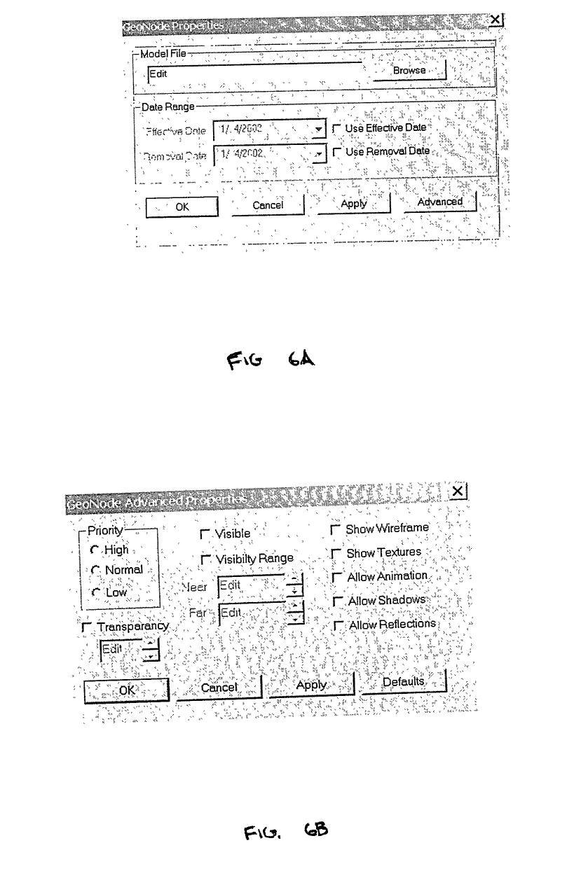

A pop-up window is then displayed to the user as shown in FIGS. 6A and 6B. The pop-window may be used to changes various attributes associated with the physical structure. Of particular importance, the interactive visualization tool 10 allows the user to set a time period during which the physical structure exists in the geographical scene; other modifiable attributes may include (but is not limited to) color, size, or material of the physical structure. It is readily understood that user input data for such modifiable attributes is embodied in the corresponding node of the hierarchical tree structure 42.

While the invention has been described in its presently preferred form, it will be understood that the invention is capable of modification without departing from the spirit of the invention as set forth in the appended claims.

What is claimed is:

1. A computer-implemented system that enables interactive visualization of a geographical scene having one or more physical structures residing therein, comprising:
a model database for storing three-dimensional model data for the physical structures which may reside in the geographical scene;
a scene definition data structure that represents the geographical scene, the scene definition data structure comprised of a tree structure having a plurality of nodes, such that each node represents a physical structure residing in the geographical scene and each node includes a time period during which the physical structure exists in the geographical scene and link data to corresponding model data residing in the model database; and
a scene definition application connected to the model database and the scene definition data structure, the scene definition application adapted to receive a time and operable to interactively display the geographical scene in accordance with the specified time.

2. The computer-implemented system of claim 1 wherein the scene definition application displays physical structures in the geographical scene, where the specified time falls within the time period associated with each physical structure displayed in the geographical scene.

3. The computer-implemented system of claim 1 wherein the time period associated with each node in the tree structure is further defined as an effective date and a removal date.

4. The computer-implemented system of claim 1 wherein at least two nodes having different time periods, such that the physical structures displayed in the geographical scene varies over time.

5. The computer-implemented system of claim 1 wherein the scene definition data structure is implemented in an object oriented form, such that each node is a data object instantiated from a common object class and assembled in a direct acyclic graph.

6. The computer-implemented system of claim 1 wherein the scene definition data structure is comprised of two or more tree structures, such that each tree structure represents a different geographical scene.

7. The computer-implemented system of claim 1 further includes a graphics engine, the graphics engine being cooperatively operable with the scene definition application to render the model data for each physical structure displayed in the geographic scene.

8. The computer-implemented system of claim 7 wherein the scene definition application cooperatively operable with the graphics engine to dynamically build a scene graph which parallels the tree structure of the scene definition data structure, the scene graph being used by the graphics engine to render the model data for each physical structure displayed in the geographic scene.

9. The computer-implemented system of claim 8 wherein the scene graph is further defined to include a data node and a corresponding switch node for each node in the tree structure of the scene definition data structure, where each switch node dictates whether the model data associated with the data node is to be rendered by the graphics engine.

10. The computer-implemented system of claim 9 wherein scene definition application is further operable to update the plurality of switch nodes in the scene graph based on the specified time and the time periods embodied in the plurality of nodes in the tree structure of the scene definition data structure.

11. The computer-implemented system of claim 7 wherein the scene definition application is operable to dynamically build a window tree which parallels the tree structure of the scene definition data structure, where the window tree is displayed on a graphical user interface of the system.

12. A method for displaying a geographical space having one or more physical structures residing therein, comprising:
storing three-dimensional model data for the physical structures which may reside in the geographical scene in a model database;
defining a scene definition data structure that represents the geographical space, the scene definition data structure comprised of a tree structure having a plurality of nodes, such that each node represents a physical structure residing in the geographical space and each node includes a time period during which the physical structure exists in the geographical space and link data to corresponding model data residing in the model database;
specifying a time at which to represent the geographical space; and
rendering model data for the physical structures residing in the geographical space at the specified time, thereby displaying the geographical space.

13. The method of claim 12 wherein the step of rendering model data further comprises comparing the specified time with the time period associated with each physical structure which may reside in the geographical space, and displaying a given physical structure when the specified time falls within the time period associated with the given physical structure.

14. The method of claim 12 wherein the step of defining a scene definition data structure further comprises defining the time period associated with each node in the tree structure as an effective date and a removal date.

15. The method of claim 12 wherein the step of defining a scene definition data structure further comprises implementing the scene definition data structure in an object oriented form, such that each node is a data object instantiated from a common object class and assembled in a direct acyclic graph.

16. The method of claim 12 further comprises dynamically building a scene graph which parallels the tree structure of the scene definition data structure, the scene graph being used by a graphics engine to render the model data for each physical structure displayed in the geographic space.

17. The method of claim 16 wherein the scene graph is further defined to include a data node and a corresponding switch node for each node in the tree structure of the scene definition data structure, such that each switch node dictates whether the model data associated with the data node is to be rendered by the graphics engine.

18. The method of claim 17 further comprises updating the plurality of switch nodes in the scene graph based on the specified time and the time periods embodied in the plurality of nodes in the tree structure of the scene definition data structure.

19. The method of claim 12 further comprises dynamically building a window tree which parallels the tree structure of the scene definition data structure, where the window tree is displayed on a graphical user interface.
